(19) United States
(12) Patent Application Publication
(10) Pub. No.: US 2023/0364800 A1
(43) Pub. Date: Nov. 16, 2023

(54) VIRTUAL AND PHYSICAL SOCIAL ROBOT WITH HUMANOID FEATURES

(71) Applicant: HUMAN CENTRED INNOVATIONS PTY LTD, Greensborough (AU)

(72) Inventors: Rajiv Khosla, Greensborough (AU); Khanh Tuan Nguyen, Greensborough (AU)

(21) Appl. No.: 18/028,983

(22) PCT Filed: Jun. 30, 2021
(86) PCT No.: PCT/AU2021/050698

§ 371 Date: Mar. 28, 2023

(30) Foreign Application Priority Data
Sep. 29, 2020 (AU) 2020903504
Feb. 1, 2021 (CN) 202110133608.1

(51) Int. Cl. B25J 11/00; B25J 13/00; B25J 9/16

(52) U.S. Cl. CPC B25J 11/0005; B25J 13/003; B25J 9/1697

(57) ABSTRACT

A human interaction system for interaction by a user comprising social systems comprising at least a social robot and one or more virtual robot systems, and a coordination system, wherein: the social robot is controlled by a robot processing system and is configured to provide interaction with a user, said interaction including output means and input means, the one or more virtual robot systems are configured to controllably present an avatar representation of the social robot, and further configured to receive inputs, the coordination system is configured to coordinate operation of the social robot and the one or more virtual robots such that, at any one time, either the social robot or one of the virtual robot systems is active, such that, in operation, a user perceives a robot personality associated with the social robot and the avatar as associated with the active social robot or virtual robot system.

### FIELD OF THE INVENTION

The invention generally relates to a human interaction system for interaction by a user with interrelated physical and virtual representations of a social robot.

### BACKGROUND TO THE INVENTION

Social robots are known which are designed to meet certain requirements in appearance and function for use in human care scenarios. For example, such robots may comprise moveable parts as well as the ability to produce visual and audio outputs that provide a relatable interactive experience for a user—that is, the social robot is designed with a view to encouraging interaction and a feeling of attachment between the user and the social robot. Citations [1]-[5] describe the characteristics desirable in a physical social robot in this regard, for example, under the heading “Our social robot characteristics” of reference [3]. The citations include discussion of features suitable for autism care and care of the elderly, in particular, in relation to care of those with dementia. Such social robots may be said to have their own personality, which typically extends to including a name—that is, the social robot embodies a personality. The design of the social robot intends for this through selection of physical design features and, typically, audible and/or visual design features.

However, existing systems rely solely on a physical robot. Although suitable designs have been found to improve engagement and, therefore, effectiveness in care, further developments are required.

Social robots can provide for a level of engagement and monitoring for people requiring care that can help to take some of the workload off carers. A known social robot is the present Applicant's Matlda robot (reference [7]), which provides human-like engagement and sensory enrichment to users. For example, Matlda has been designed to have a friendly appearance while providing user-friendly interactivity.

### SUMMARY OF THE INVENTION

According to an aspect of the present invention, there is provided a human interaction system for interaction by a user comprising social systems comprising at least a social robot and one or more virtual robot systems, and a coordination system, wherein: the social robot is controlled by a robot processing system and is configured to provide interaction with a user, said interaction including output means and input means, the one or more one or more virtual robot systems are configured to controllably present an avatar representation of the social robot, and further configured to receive inputs, the coordination system is configured to coordinate operation of the social robot and the one or more virtual robots such that, at any one time, either the social robot or one of the virtual robot systems is active, such that, in operation, a user perceives a robot personality associated with the social robot and the avatar as associated with the active social robot or virtual robot system.

The social robot may comprise one or more cameras and/or a microphone as input means, and/or the social robot may comprise a speaker and/or one or more lights as output means.

The coordination system may be in data communication with the social robot and the one or more virtual robot systems.

The social robot may comprise a first portion, such as a head, moveable with respect to a second portion, such as a body.

The coordination system may be configured to: determine a location of the user and to determine a corresponding social system to the location of the user; and communicate a message to the corresponding social system configuring it as active. The coordination system may be further configured to: communicate a message to the one or more other social systems configuring each as inactive. The coordination system may be configured to receive a present communication from each social system, and the present communication may be generated in response to an input means of the social system indicating the presence of the user at a physical location associated with the social system.

The one or more virtual robot systems may be configured to animate the avatar, and at least one animation may be equivalent to a movement of the social robot.

The one or more virtual robot systems may be configured to animate the avatar, and at least one animation may be not equivalent to a movement of the social robot.

The robot processing system may be configured to control, at least in part, the operation of an active virtual robot system. The active virtual robot system may be configured to interpret commands received from the robot processing system and adapt said commands for display on a display of the virtual robot system.

At least one virtual robot system may be configured with at least two predefined avatar appearances, and one of said predefined avatar appearances may be selected in dependence on an application. One of the predefined avatar appearance may be a neutral appearance.

At least one virtual robot system may be configured with at least two predefined virtual environments over which the avatar is presented.

The system may further comprise one or more interaction devices in data communication with the social robot and/or virtual robot system(s), the interaction devices enabling the user to provide inputs and receive outputs. At least one virtual robot system may be configured to present a virtual object corresponding to an interaction device.

The social robot and/or at least one virtual robot system may be configured for data communication with one or more auxiliary devices.

The avatar appearance may be controllable in response to a user command to perform a verbal communication and/or a visual action.

According to another aspect of the present invention, there is provided a human interaction system for interaction by a user comprising social systems comprising at least a social robot and one or more virtual robot systems, wherein: the social robot is controlled by a robot processing system and is configured to provide interaction with a control user, said interaction including output means and input means, the one or more one or more virtual robot systems are configured to controllably present an avatar representation of the social robot, and further configured to receive inputs, wherein the, or each, virtual robot system is associated with a user, such that, in operation, the, or each, user perceives a robot personality associated with the social robot and the avatar as associated with the active social robot or virtual robot system.

The social robot may comprise one or more cameras and/or a microphone as input means, and/or the social robot may comprise a speaker and/or one or more lights as output means.

The social robot may comprise a first portion, such as a head, moveable with respect to a second portion, such as a body.

The one or more virtual robot systems may be configured to animate the avatar, and at least one animation may be equivalent to a movement of the social robot.

The one or more virtual robot systems may be configured to animate the avatar, and at least one animation may be not equivalent to a movement of the social robot.

The robot processing system may be configured to control, at least in part, the operation of an active virtual robot system.

At least one virtual robot system may be configured with at least two predefined avatar appearances, and one of said predefined avatar appearances may be selected in dependence on an application. One of the predefined avatar appearance may be a neutral appearance.

At least one virtual robot system may be configured with at least two predefined virtual environments over which the avatar is presented.

The system may further comprise one or more interaction devices in data communication with the social robot and/or virtual robot system(s), the interaction devices enabling the user to provide inputs and receive outputs. At least one virtual robot system may be configured to present a virtual object corresponding to an interaction device.

The social robot and/or at least one virtual robot system may be configured for data communication with one or more auxiliary devices.

The social robot may be configured to receive voice commands from the control user, at least one voice command may correspond to a request for information from a particular virtual robot system, and the social robot may be further configured to: communicate said command to said particular virtual robot system. The social robot may be further configured to: receive a response to said command from the particular virtual robot system. At least one virtual robot system may be further configured to: receive a directed command; undertake an associated action; and communicate a response to the social robot. At least one associate action may comprise obtaining a result from an associated auxiliary device in communication with the associated virtual robot system.

The avatar appearance may be controllable in response to a user command to perform a verbal communication and/or a visual action.

According to another aspect of the present invention, there is provided a human interaction method for allowing interaction by a user with a social system comprising at least a social robot and one or more virtual robot systems, comprising: controlling the social robot to provide interaction with a user, said interaction including output means and input means, controllably presenting an avatar representation of the social robot on one or more displays, such that when an avatar representation is displayed on a display it is active, and coordinating operation of the social robot and the one or more virtual robots such that, at any one time, either the social robot or one of the virtual robot systems is active, such that, in operation, a user perceives a robot personality associated with the social robot and the avatar as associated with the active social robot or virtual robot system.

The present disclosure can also be understood as including virtual avatars produced by virtual robot systems and their relationships to a physical robot, thereby providing a common relationship experience. For example, certain aspects disclosed may allow for multiple avatars to be presented at a time, where those avatars are located in different locations such as rooms—for example, virtual avatars may be presented in a hospital room while one or more physical robots are present in a common area, providing the experience that the single personality is present in both a resident's room and when the resident visits the common area.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order that the invention may be more clearly understood, embodiments will now be described, by way of example, with reference to the accompanying drawing, in which:

FIG. 1 shows a human interaction system according to an embodiment;

FIG. 2 shows features of a social robot according to an embodiment;

FIG. 3 shows features of a virtual robot system according to an embodiment;

FIG. 4 shows features of a coordination system according to an embodiment;

FIG. 5 illustrates different interaction points;

FIG. 6 shows an example of a social robot;

FIG. 7 shows a relationship between a social robot, a plurality of virtual robot systems, and a coordination system, according to an embodiment;

FIGS. 8 and 9 show methods of controlling a social robot and one or more virtual robot systems;

FIG. 10 shows examples of different visual appearances of an avatar;

FIG. 11 shows examples of different environments;

FIG. 12 shows an embodiment further comprising interaction devices;

FIG. 13 shows a relationship between an interaction device and a virtual object;

FIG. 14 shows an embodiment wherein a social robot interacts with a plurality of active virtual robot systems; and

FIG. 15 shows a social robot and a virtual robot system interacting with different auxiliary devices.

### DESCRIPTION OF EMBODIMENTS

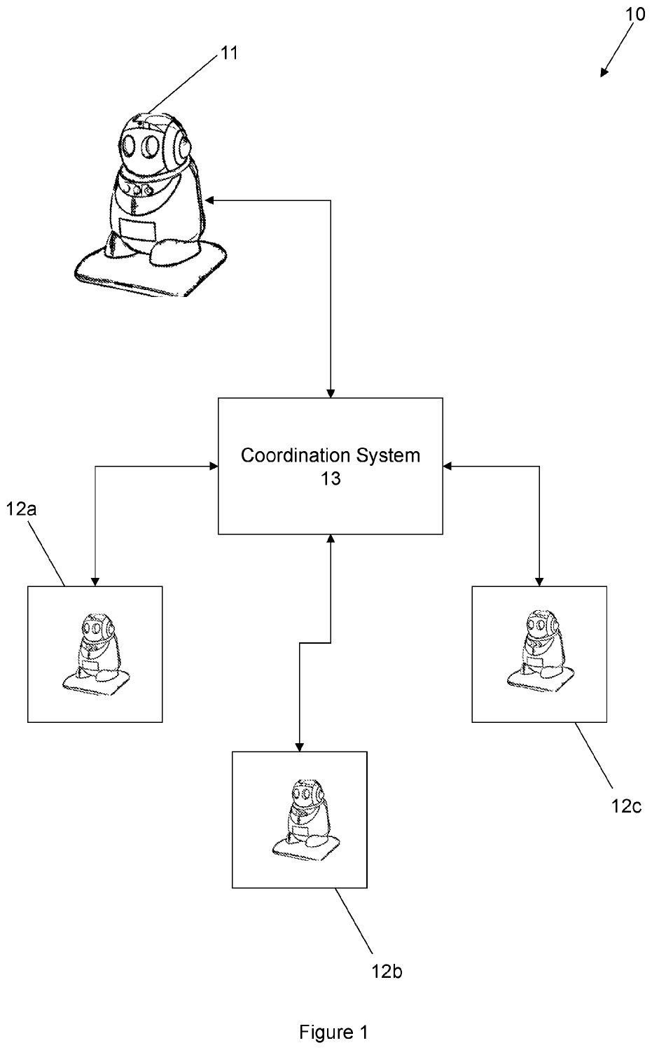

Referring to FIG. 1, according to an embodiment, a human interaction system 10 comprises a social robot 11, one or more virtual robot systems 12 (four are shown: 12a-13d), and a coordination system 13. The coordination system 13 is in data communication with the social robot 11 and the, or each, virtual robot system 12. The data communication can comprise wired and/or wireless communication, for example, the data communication can be via a network router. Example wireless standards include WiFi (802.11), Bluetooth, ZigBee, etc. Example wired standards include ethernet and USB.

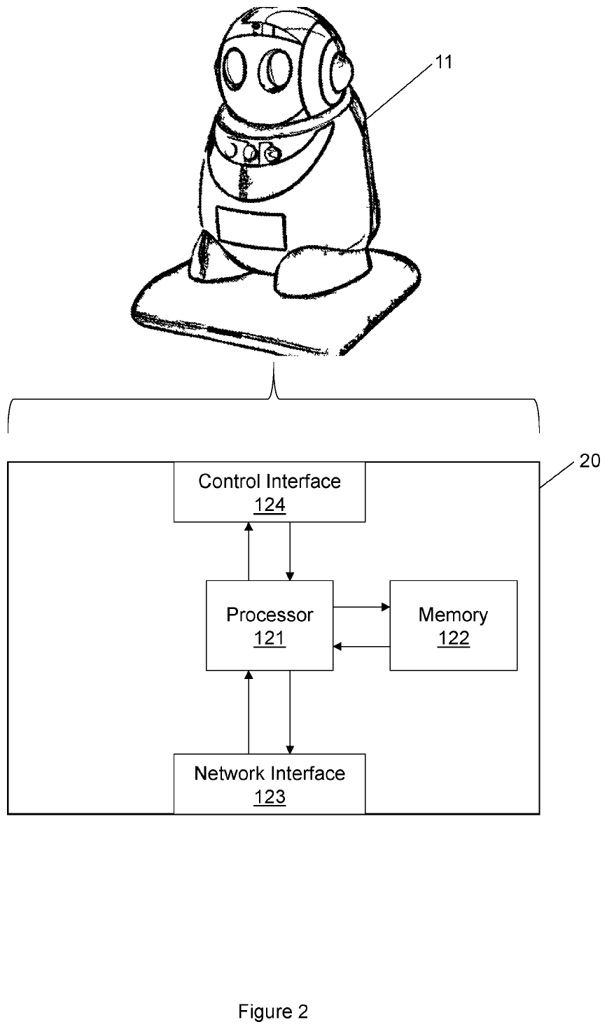

Referring to FIG. 2, according to an embodiment, the social robot 11 comprises a robot processing system 20 including one or more processors 121 (herein, one processor 121 is assumed) interfaced with a memory 122 (typically including both volatile and non-volatile memories), a network interface 123, and a control interface 124. The processor 121 is configured to read program instructions from the memory 122 and thereby cause the social robot 11 to implement the functionality herein described, for example via commands and data issued to the control interface 124. The processor 121 typically also receives data from the control interface 124 and may respond to said received data and/or store said received data in the memory 122.

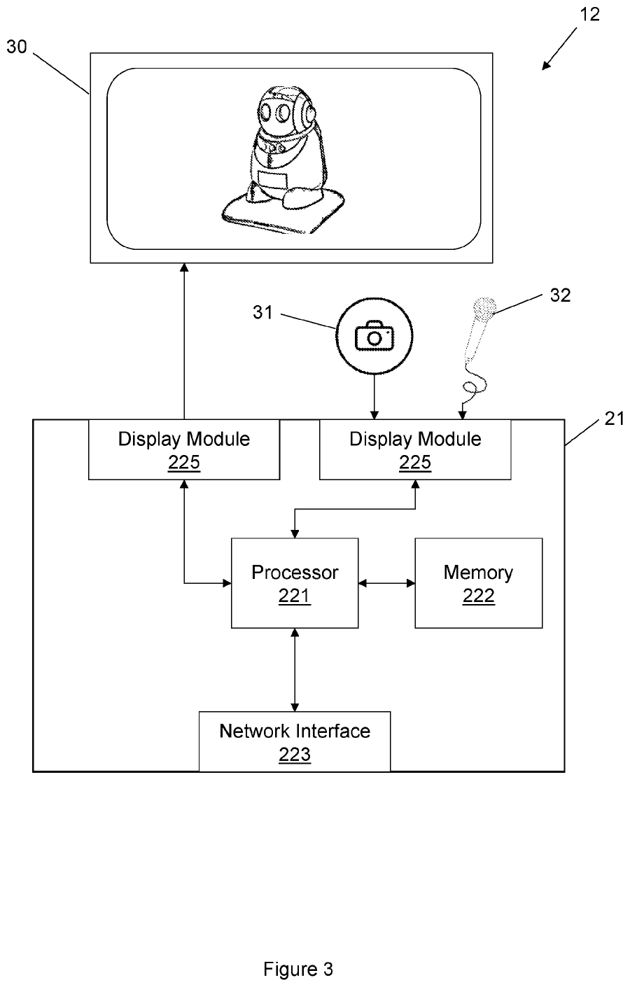

Referring to FIG. 3, according to an embodiment, a virtual robot system 12 also comprises a virtual robot processing system 21 including one or more processors 221 (herein, one processor 221 is assumed) interfaced with a memory 222 (typically including both volatile and non-volatile memories), and a network interface 223. The processor 221 is interfaced with a display module 225 configured for controlling an attached display 30 (i.e. to cause certain images etc. to be displayed on the display 30). The processor 221 is configured to read program instructions from the memory 222 and thereby cause the virtual robot system 12 to implement the functionality herein described, for example via commands and data issued to the display module 225. In an embodiment, the virtual robot processing system 21 also comprises an input module 226 configured to receive signals corresponding to user inputs—for example, via an interfaced camera 31 and/or microphone 32.

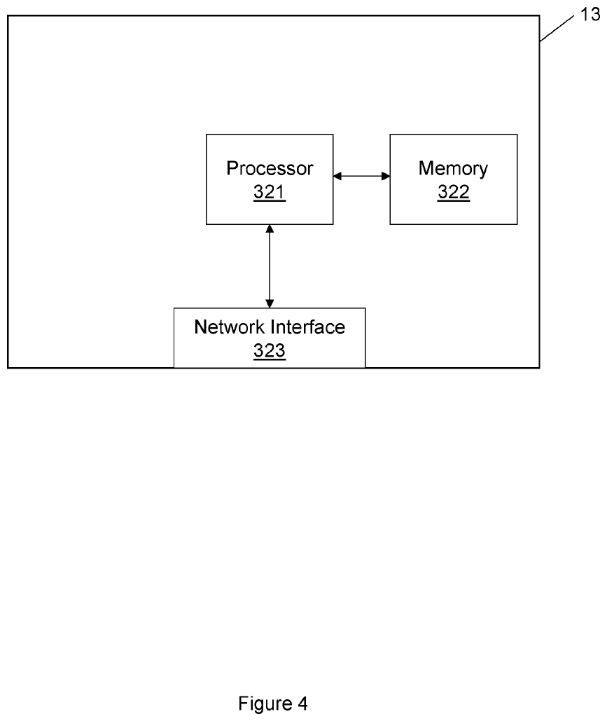

Referring to FIG. 4, according to an embodiment, the coordination system 13 comprises one or more processors 321 (herein, one processor 321 is assumed) interfaced with a memory 322 (typically including both volatile and non-volatile memories), and a network interface 323. The coordination system 13 is configured to coordinate functionality between the social robot 11 and the virtual robot system(s) 12. In an embodiment, the coordination system 13 is implemented as part of the same hardware as the robot processing system 20—in this embodiment, the coordination system 13 can be considered a software module implemented by the social robot 11. In another embodiment, the coordination system 13 is implemented in distinct hardware and is in data communication with the robot processing system 20 via respective network interfaces 123, 323.

For example, the robot processing system 20 can be configured to implement techniques for monitoring emotional state changes as described in the present Applicant's earlier PCT publication no. WO 2008/064431 A1. The control interface 124 controls the outputs of the social robot 11. These may vary depending on the particular implementation, but can include, for example, emitting visual and/or audio signals. The social robot 11 also receives input data from sensors of the social robot 11, such as from one or more cameras and/or one or more microphones. Reference is also made to citations [1], [2], [3], [4], and [5] for examples of existing operation of the robot processing system 20, each of which is incorporated herein by reference.

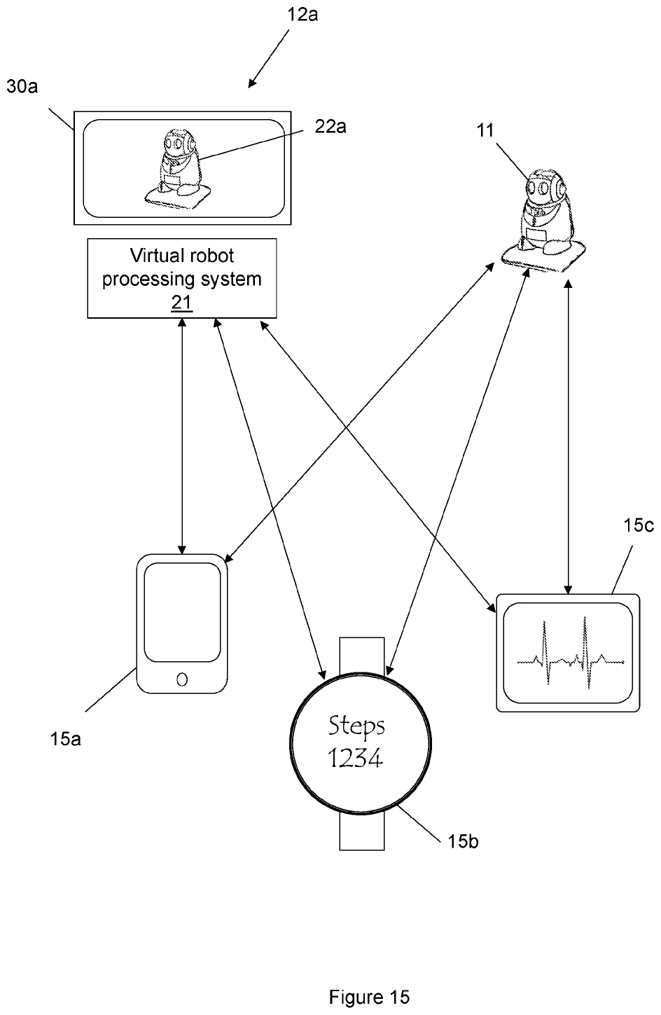

According to an embodiment, as shown in FIG. 15, a robot processing system 20 and/or a virtual robot processing system 21 can be configured for communication with local auxiliary devices 15. Such communication may be wired or wireless, and typically will utilise standard communication protocols (e.g. WiFi, Bluetooth, USB, etc.) between the robot processing system 20 and/or a virtual robot processing system 21 and the local auxiliary devices 15. The local auxiliary devices 15 are typically configured to provide an additional output and/or an additional input for the robot processing system 20 and/or a virtual robot processing system 21.

Examples of local auxiliary devices 15 include portable computing devices such as smart phones and tablets 15a, wearable technology such as activity trackers 15b, and medical monitoring devices 15c. In the latter case, the robot processing system 20 can be configured to obtain medical information relating to a patient in the same room as the robot processing system 20 and/or a virtual robot processing system 21. Generally, such devices 15 may be provided with software to enable communication with the robot processing system 20 and/or a virtual robot processing system 21 or, alternatively, an existing output of the such devices 15 can be coupled to the robot processing system 20 and/or a virtual robot processing system 21.

For example, one or more auxiliary devices 15 may be provided for measuring: heart rates; emotional profile; sleep quality; blood pressure; brain activity (EEG).

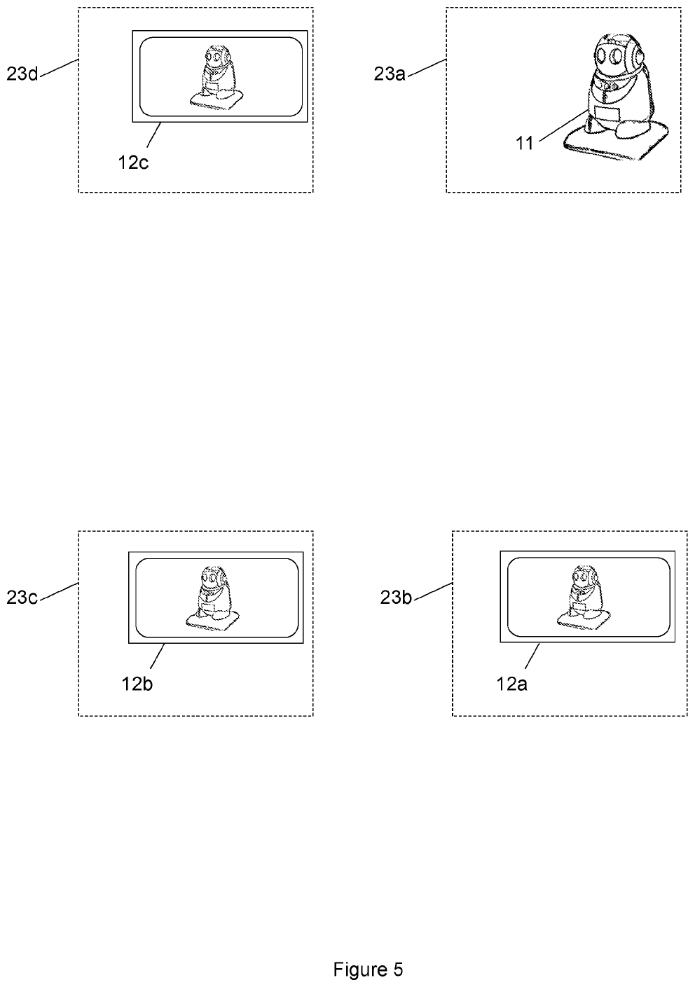

Referring to FIG. 5, according to an embodiment, the coordination system 13 is configured to enable certain aspects of the functionality of the robot processing system 20 to be implemented at the virtual robot processing system 21. The social robot 11 and the, or each, virtual robot system 12 can be considered interaction points 23 connected by the coordination system 13 (as shown in the figure). Interaction point 23a corresponds to the social robot 11, whereas interaction points 23b-23d represent individual instances of the one or more virtual robot systems 12 (four are shown: 12a-13d). The interaction points 23 represent physical locations within an environment (e.g. a house or aged care facility). It may be preferred that each interaction point 23 is located in a distinct physical location (e.g. each is located in a separate room), although this may be an implementation detail—it is envisaged that certain implementations may utilise two (or more) interaction points 23 at the same physical location.

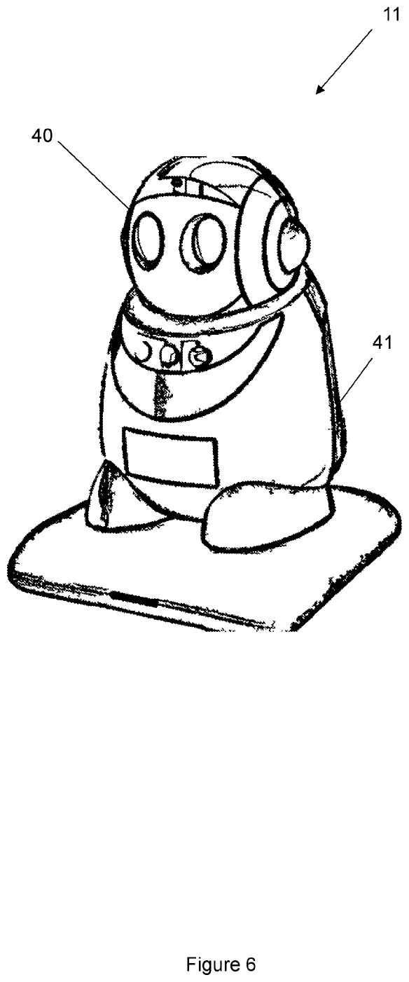

FIG. 6 shows an example of a social robot 11 according to an embodiment. The social robot 11 comprises a head 40 and a body 41, wherein the head 40 may be moveable with respect to the body 41, for example, via rotation. The social robot 11 comprises at least one camera 42—for example, the head 40 may comprise two eyes 43 one or both having an embedded camera 42 and/or at least one camera 42 may be located elsewhere. The head 40 and/or body 41 can comprise lights (e.g. LEDs, not shown) which are controllable via robot processing system 20. The head 40 and/or body 41 may comprise microphones 44 and/or speakers 45. Generally, the social robot 11 can comprise features described in the cited references [1]-[5] and/or embodied in Applicant's MATLDA product (reference [7]). The robot processing system 20 can be implanted in hardware located within the physical social robot 11 (as assumed herein), although it is expected that the hardware may be located separately—for example, via a wired connection to the social robot 11.

The social robot 11 may be moveable via a trolley or similar vehicle or via physical lifting. However, both techniques pose problems—for example, a trolley does not readily facilitate movement in a vertical direction (up or down stairs, for example) and it has been found that physical lifting can lead to injury or misplacement of the social robot 11. The latter problem can be significant—for example, if a social robot 11 is placed too close to an edge of an elevated position (e.g. table), it may fall off, risking both physical damage and potential emotional distress for the user.

Unless a distinction is required, for convenience, herein reference to a social robot 11 should be understood to include reference to its robot processing system 20. Similarly, reference to a virtual robot system 12 should be understood to include its virtual robot processing system 21.

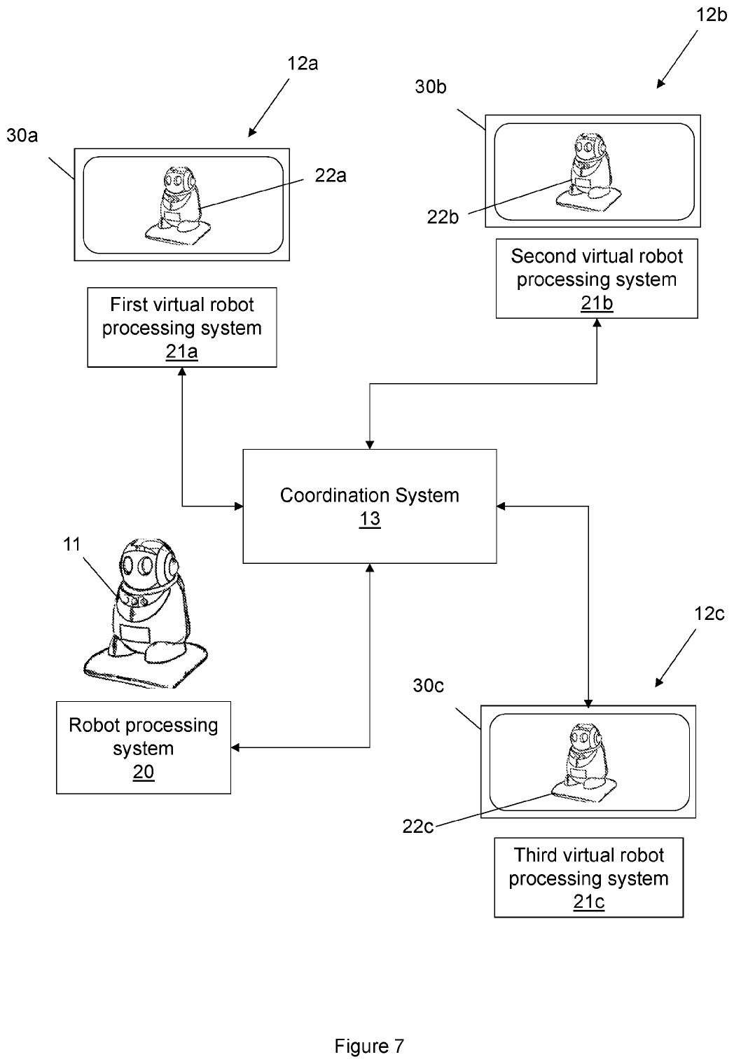

FIG. 7 shows an embodiment comprising the social robot 11 interfaced with the coordination system 13 which is itself interfaced with one virtual robot system 12a. As shown in the figure, the display 30 of the virtual robot system 12a shows graphical representation of the social robot 11 referred to herein as an avatar 22—that is, there is a level of similarity between the physical appearance of the social robot 11 and the avatar 22. Depending on the embodiment, as will become clear, there can be variations in appearance of the avatar 22—this may depend on a particular function being performed. However, it may be generally preferred that the user is encouraged to believe that the personality embodied by the avatar 22 is the same as that embodied by the social robot 11. This may manifest as a design consideration when designing the avatar 22.

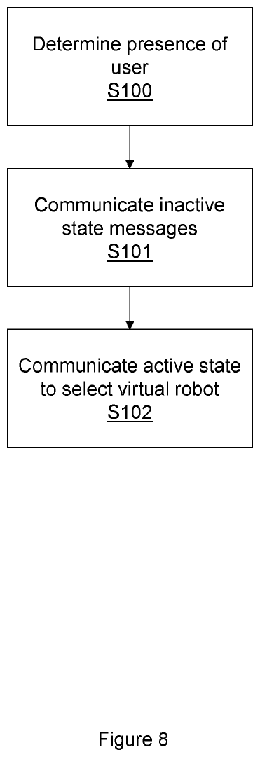

FIG. 8 shows an embodiment wherein the virtual robot system 12a is controlled such that the avatar 22 is displayed in response to determining that the user is in a physical location in which the particular virtual robot system 12a is located. For convenience, reference herein is made to the physical location being a room of a building such as a house, and therefore, the virtual robot system 12a is associated with the room.

At step S100, the coordination system 13 determines that the user is in the room associated with a particular virtual robot system 12a. In an embodiment, the virtual robot processing system 21 is configured to determine the presence of the user based on inputs received from its sensors and to communicate a message to the coordination system 13 indicate said presence. In another embodiment, the virtual processing system 21 is configured to communicate said sensor data to the coordination system 13, which determines the presence of the user. According to an embodiment, the virtual robot system 12a identifies the presence of the user via its equipped camera 31 using human recognition algorithms known in the art. Alternatively, or in addition, the user may be provided with a radio frequency identifier that is configured to be readable by a suitably configured scanner interfaced with the virtual robot system 12a.

At step S101, the coordination system 13 communicates messages to the social robot 11 and any other virtual robot systems 12b-12d configured to inform each device that it is to be in an inactive state. The meaning of “inactive state” may vary depending on the particular embodiment and whether the device is a social robot 11 or a virtual robot system 12. However, generally, when in an inactive state, the particular device is configured to not undertake functions corresponding to the robot personality. For example, a display 30 of an inactive virtual robot system 12 can be configured to not display a representation of the avatar 22. In another example, an inactive physical social robot 11 can be configured to limit or entirely halt output functionality such as the illumination of lights, emission of sounds, or movement of parts such as the head 40 with respect to the body 41.

At step S102, the coordination system 13 communicates to the virtual robot system 12a associated with the physical location of the user a message indicating that it is to be in an active state. The meaning of “active state” may vary depending on the particular embodiment. In a general sense, when in an active state, the virtual robot system 12 is configured to present a visual representation of the avatar 22. Similarly, the social robot 11 can be in an active state, in which case it is undertaking functions associated with its robot personality.

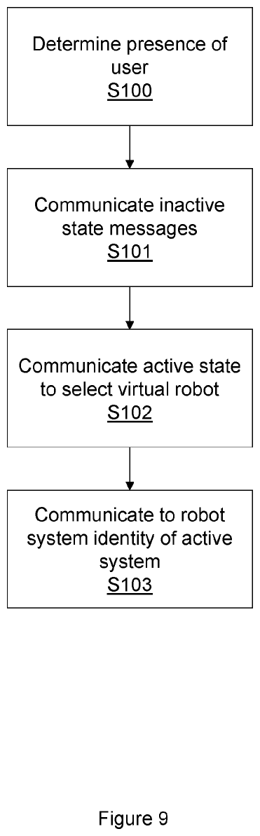

Referring to FIG. 9, in an embodiment, the robot processing system 20 is configured to interface with the active virtual robot processing system 21, such that at least a portion of the processing required to present the visual representation of the avatar 22 is provided by the robot processing system 20. Accordingly, the method of FIG. 9 includes the steps of FIG. 8 with an additional step S103 of the coordination system 13 communicating a message to the robot processing system 20 configured to enable the robot processing system 20 to interface with the active virtual robot processing system 21. For example, the message may comprise an ID code associated with the active virtual robot processing system 21.

The embodiments described in reference to FIGS. 8 and 9 may advantageously address a need for the user to be able to interact with the system 10 despite moving between different physical locations, without requiring movement of the social robot 11. From the perspective of the user, the robot personality appears to move between physical locations as the user moves between the locations. The robot personality may appear to move between being active within the social robot 11 (i.e. social robot 11 is in an active state and the one or more virtual robot systems 12 are in an inactive state) and being active within a virtual robot system 12 (one virtual robot system 12 is in an active state at a time, and the remainder (where applicable) as well as social robot 11 are in an inactive state) as an avatar 22, therefore, from the perspective of the user, the robot personality is able to move without requiring movement of the actual social robot 11.

According to an embodiment, the robot processing system 20 is configured for at least partial control of an active virtual robot processing system 21. For example, in such an embodiment, the robot processing system 20 may operate as a server and the virtual robot processing system 21 operates as a client. Accordingly, the active virtual robot processing system 21 is configured to communicate received inputs, for example, from its microphone, camera(s), and/or other input means to the robot processing system 20. The communication can be facilitated by the coordination system 13.

The robot processing system 20 is configured to cause the virtual robot processing system 21 to undertake corresponding functions to those that would otherwise be performed by the social robot 11. For example, the robot processing system 20 can be configured to communicate commands to the virtual robot processing system 21 instructing the virtual robot processing system 21 to implement a certain presentation function.

According to an embodiment, the virtual robot processing system 21 processes received commands to determine the associated presentation function and to, in response, create a corresponding presentation. For example, the command may correspond to the avatar 22 looking in a particular direction (e.g. left or right). In this example, the virtual robot processing system 21 is configured with predefined programming such as to create the appearance of a virtual representation of the avatar 22 looking in the corresponding direction. Therefore, according to this embodiment, the robot processing system 20 is not configured to directly control the outputs of the virtual robot processing system 21—instead, the control is as to what function is to be implemented by the virtual robot processing system 21. The actual task of implementing the function is left to the virtual robot processing system 21. This embodiment may provide an advantage in that relatively low bandwidth communications are required between the virtual robot processing system 21 and the robot processing system 20.

According to an embodiment, the virtual robot processing system 21 is configured to communicate to the robot processing system 20 that it has completed implementing a received function. The robot processing system 20 can therefore be configured to maintain in its memory 122 a current state of the virtual robot processing system 21 relevant to operation of the avatar 22. For example, the current state can be determined based upon the received communications from the virtual robot processing system 21.

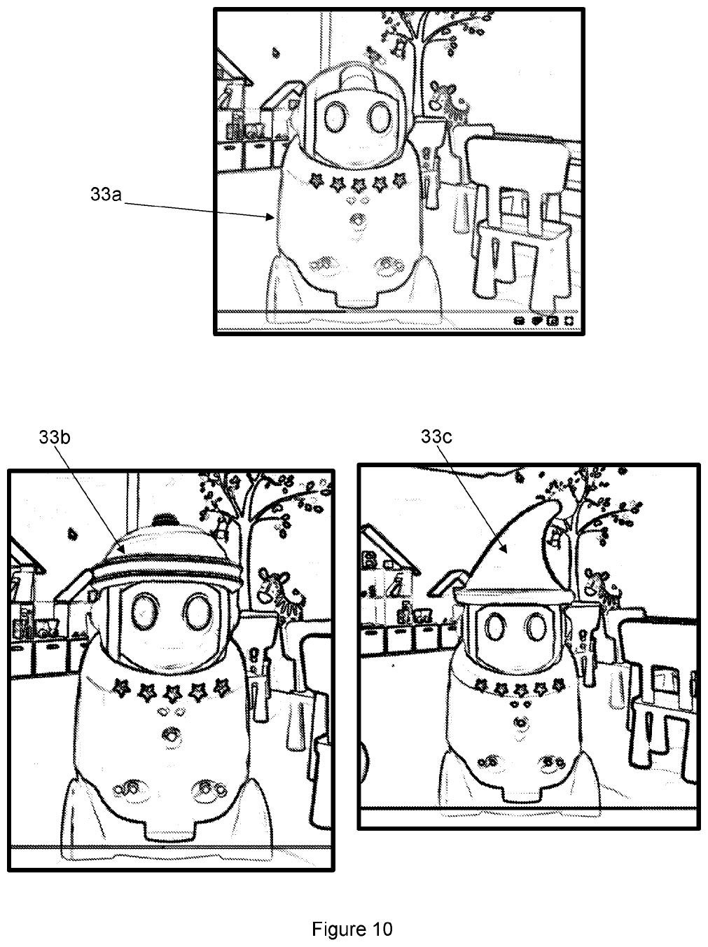

According to an embodiment, with reference to FIG. 10, a plurality of virtual representations 33 of the avatar 22 can be predefined within the system 10. In the embodiment described here, the predefined virtual representations 33 can be stored with the memory 222 of the virtual robot processing system(s) 21. However, in an embodiment, the predefined virtual representations 33 can be stored with the memory 122 of the robot processing system 20 (for example) and communicated to the virtual robot processing system(s) 21 as needed.

In the example shown in FIG. 10, there is a neutral representation 33a. This representation may be employed except where a special circumstance applies, therefore, the neutral representation may be considered a default representation. Additional representations 33b-33c are provided—it may be preferred that these additional representations 33b-33c have a sufficient similarity to the neutral representation 33a such that the user believes that the additional representations 33b-33c correspond to the same avatar as the neutral representation 33a. The additional representations 33b-33c correspond to certain activities that may be implemented by the system 10. For example, the underlying neutral representation 33a can be modified through the appearance of different clothing, different size, colours, etc.

The virtual robot processing system 21 is therefore configurable to display a selected virtual representation 33 based upon a current function—an instruction may be communicated, for example, from the robot processing system 20 to the virtual robot processing system 21 to indicate which virtual representation 33 is to be displayed. In an embodiment, where the virtual robot processing system 21 is instructed to change between virtual representations 33, a change animation may be employed.

According to an embodiment, the avatar 22 may be designed such as to express a larger number of movements than compared to the social robot 11. For example, the social robot 11 may be limited to rotational movements of its head 40 with respect to its body 41. However, the avatar may be preconfigured for additional movements—for example, translational movement of the head 40 with respect to the body 41. The avatar may be configured to move with respect to the display 30—for example, from left to right and/or up and down. In general, it should be understood, many different animations are possible. It may be preferred that the avatar 22 retain throughout said motions its visual identity—that is, the user should perceive the avatar 22 to be the same virtual object at all times. Advantageously, the avatar 22, although representing the social robot 11, effectively has available more degrees of freedom in which to move.

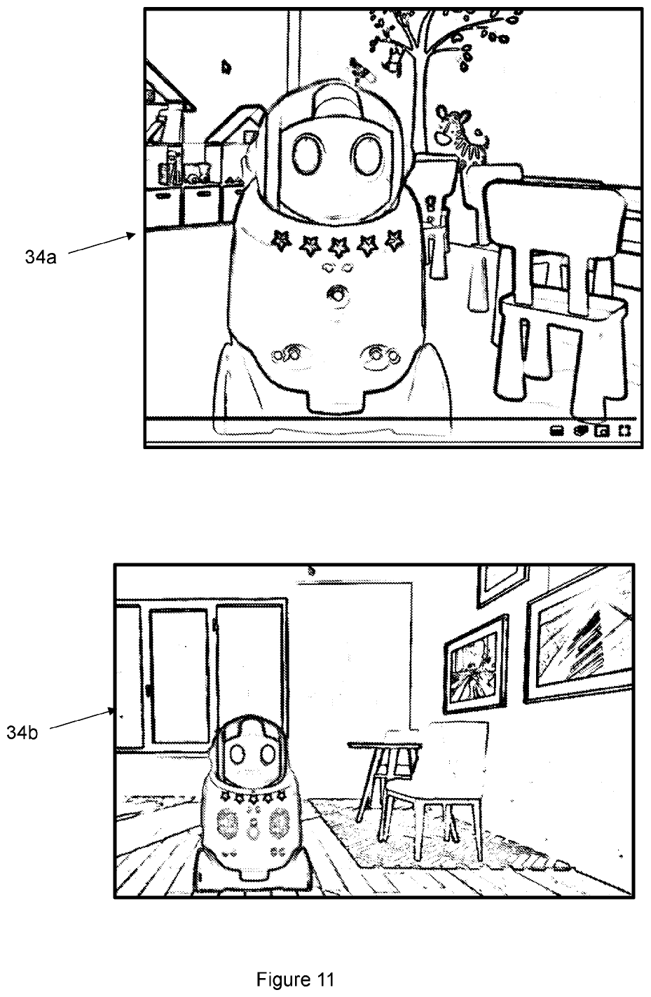

Referring to FIG. 11, according to an embodiment, a plurality of virtual environments 34 can be predefined within the system 10. In the embodiment described here, the predefined virtual environments 34 can be stored with the memory 222 of the virtual robot processing system(s) 21. However, in an embodiment, the predefined virtual environments 34 can be stored with the memory 122 of the robot processing system 20 (for example) and communicated to the virtual robot processing system(s) 21 as needed.

In the example shown in FIG. 11, there is a default virtual environment 34a. This default virtual environment 34a may be employed except where a special circumstance applies. In an embodiment, the default virtual environment 34a depends upon the particular virtual robot processing system 21. For example, each virtual robot processing system 21 can be associated with a physical location and the default virtual environment 34a is designed to match features of the physical location. For example, a physical location being a lounge may have a default virtual environment 34a including common features of a lounge, such as a virtual couch and virtual television. Advantageously, a default virtual environment 34a dependent on the particular physical location may advantageously provide higher engagement with the avatar 22 as it may appear to the user that the avatar 22 is in the same general environment as the user. Another possible advantage is where the user moves between physical locations, it appears that the general environment of the avatar 22 also changes as the particular interaction point 23 changes.

Additional virtual environments 34 may be provided, such as office environment 34b. The additional virtual environments 34 correspond to certain activities that may be implemented by the system 10. For example, these may represent such ideas as a school, a kindergarten, an office, a home, a reception, etc. These allow the user to believe that the avatar 22 has moved to one of these locations, which may be triggered when the robot processing system 20 determines to undertake a particular activity with the user (as described in relation to a social robot 11 in the prior art). For example, it may be that a kindergarten application is begun in which the system 10 presents a kindergarten activity to the user. In this case, the virtual environment 34 displayed on the active display 30 can be changed to reflect a kindergarten virtual environment 34.

The virtual robot processing system 21 is therefore configurable to display a selected virtual environment 34 based upon a current function—an instruction may be communicated, for example, from the robot processing system 20 to the virtual robot processing system 21 to indicate which virtual environment 34 is to be displayed. In an embodiment, where the virtual robot processing system 21 is instructed to change between virtual environments 34, a change animation may be employed. For example, the virtual environment 34 of a kindergarten may include a playground, toy(s), table(s), chair(s), etc. The avatar 22 will then be presented within this virtual environment 34, potentially a virtual representation 33 selected also in accordance with the application (e.g. the avatar 22 may be dressed for kindergarten, for example, having a school backpack).

Examples of embodiments represented by FIGS. 10 and 11 include:
Requesting the avatar 22 to sing a song, tell a story, or otherwise verbally communicate with the user (perform an audible action). The virtual robot system 12 can display a specially selected background corresponding to the song/story/verbal communication and may change the avatar's appearance. For example, a Christmas story or song may be accompanied by a festive appearance of the avatar 22 and a background comprising a Christmas tree.
Request the avatar 22 to perform a dance or other movement, or more generally, perform a visual action. The virtual robot system 12 can display a specially selected background corresponding to the visual action (e.g. dance) and may change the avatar's appearance. For example, the avatar 22 may undertake a sports game while dressed in a user's favourite team colours with a background matching the particular sport.

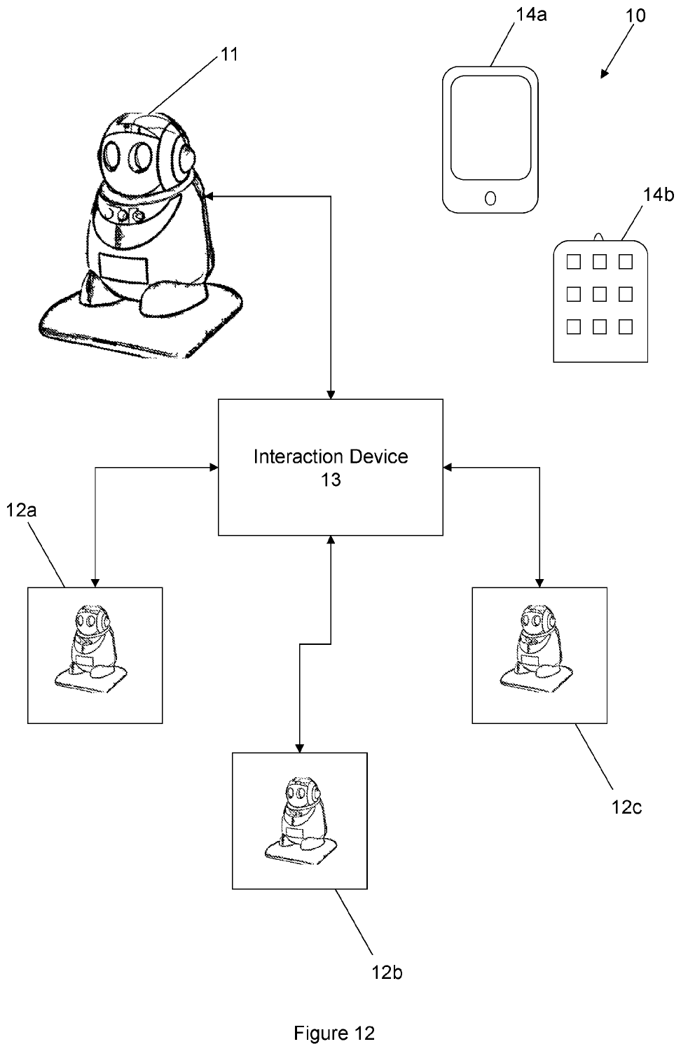

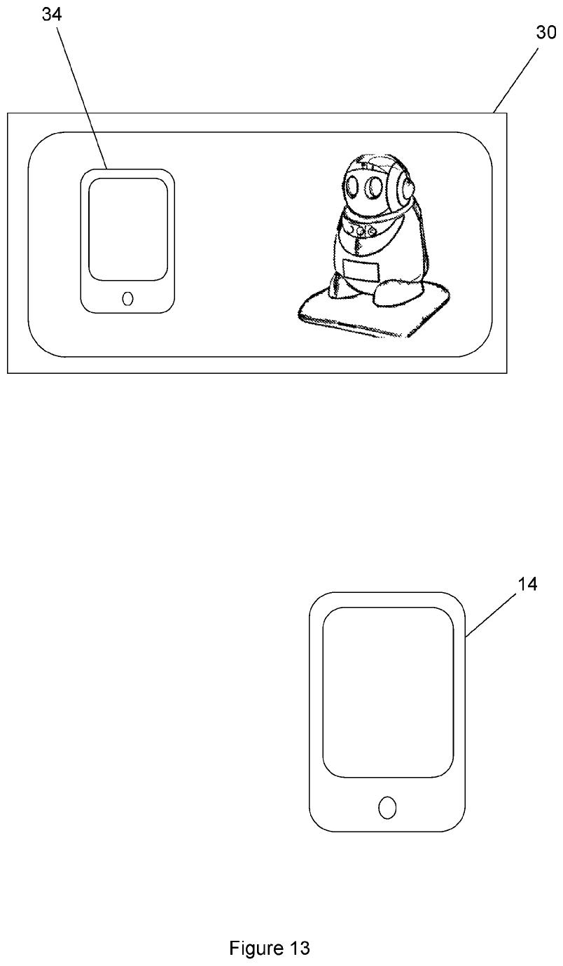

Referring to FIG. 12, according to an embodiment, the system 10 comprises one or more interaction devices 14 in data communication with the robot processing system 20 and/or virtual robot processing system 21. Referring to FIG. 13, according to an embodiment, at least one interaction device 14 is associated with a virtual object 34. The virtual robot processing system 21 or the robot processing system 20 may create a link between an interaction device 14 and a particular virtual object 34. It may be that the virtual object 34 visually represents that interaction device 14—for example, if the interaction device 14 is a tablet, then the virtual object 34, when displayed on the active display 30, is configured to appear as a tablet. Thus, advantageously, the user easily understands the relationship between the physical interaction device 14 and the onscreen representation. The link may be created dynamically—for example, in response to the interaction device 14 being connected into system 10 or in response to a particular application being run that may utilise said interaction device 14.

According to the embodiment of FIG. 13, the use is provided with multiple access points to the system 10, which may be useful when undertaking particular activities. For example, the avatar 22 may guide the user to utilising an interaction device 14 in order to interact with the system 10.

The virtual environment 33, virtual objects 34, and/or appearance of the avatar 22 may be determined dynamically depending on the application context. For example, when the user asks “read McDonald has a farm” story, the content of the story may be analysed. Then a virtual farm scene as the virtual environment 34 will be rendered together with 3D animals (i.e. virtual objects 34), their animations, and sound effects will be created and synched with the storytelling progress.

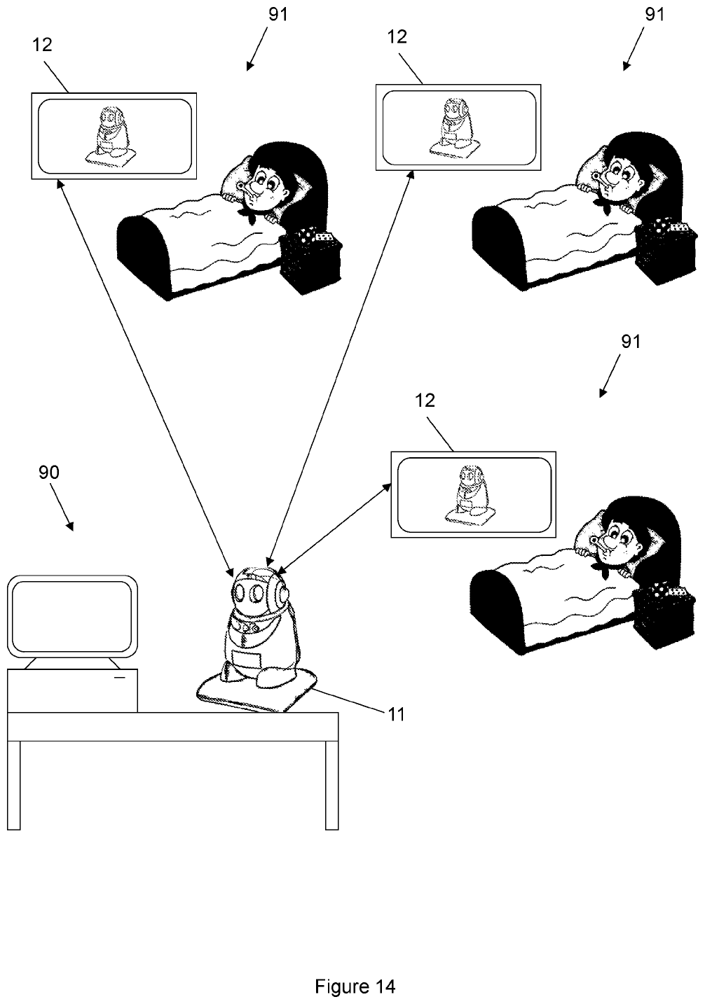

According to an embodiment, with reference to FIG. 14, a social robot 11 is in communication with one or more virtual robot systems 12. According to this embodiment, a plurality of the social robot 11 and one or more virtual robot systems 12 can be in an active state at the same time. As shown in FIG. 14, each virtual robot system 12 can be associated with a user, for example, a patient or rest home resident. Typically, at least two users are different, and it may be preferred that each user is different.

Social robot 11 is associated with a control user and can be configured in a control mode—this is different to the active mode described above although the control mode may include the functionality of some or all of a social robot 11 in active mode. The robot processing system 20 is configured, in the control mode, to direct commands to particular virtual robot processing systems 21 in response to an instruction issued by the control user. The commands are configured to cause a receiving virtual robot processing system 21 to undertake an action, which may result in a response being communicated to the robot processing system 20. In this way, the control user is enabled to cause actions to occur at particular virtual robot systems 12 which may be remote from the control user.

The social robot 11 can be preconfigured with one or more voice commands. The social robot 11 can further be configured to interpret sensed voiced commands to identify the associated voice command. Furthermore, the voice command can be associated with a virtual robot system 12 identifier also spoken by the control user.

FIG. 14 more specifically shows an example in a hospital, where a nurse station 90 is provided with a social robot 11 and each of a plurality (three in the figure) of patient rooms 91 are provided with virtual robot systems 12a-12c. A nurse interacts with the social robot 11, for example, verbally, by issuing a command to the social robot 91. For example, the nurse may issue a voiced command “send me vital signs of John”, where “John” is a user associated with a particular virtual robot system 12. The social robot 11 then issues a command to the particular virtual robot system 12 requesting that it return a value or values corresponding to the vital signs. In this case, the virtual robot system 12 is interfaced with one or more medical devices configured to measure and provide vital sign information. After obtaining said vital sign information, the corresponding values are communicated to the social robot 11. The social robot 11 then reports these values, for example, using a speaker output.

An advantage of providing for a social robot 11 as well as a plurality of virtual robot systems 12 may be that the social robot 11 provides a physical representation of the avatars 22 of the virtual robot systems 12. A patient (in this example) may be aware of the physical social robot 11 present at, in this case, the nurse station 90. Therefore, the patient may associate the avatar 22 with the nurse station 90 and the nurses occupying the nurse station 90. Therefore, through the perceived association, the patient may advantageously be more inclined to treat the avatar 22 as a “real” entity rather than simply a virtual animation.

Another implementation example provides for one or more social robots 11 and a plurality of virtual robot systems 12 within a residential aged care facility. The social robot(s) 11 can be placed within common areas, such as a lounge or dining area, or at a carer's desk. The virtual robot systems 12 can each be placed in the rooms of different residents. Similar to the above example, the residents can learn to associate the virtual avatars 22 with the physical social robots 11. A social robot 11 can be configured to undertake group-based activities in the common area (e.g. bingo games) while the virtual robot systems 12 provide more personalised functions for the specific associated residents, for example, monitoring, therapeutics, and social connectivity services.

More generally, an advantage of one or more embodiments described herein is that a user is encouraged and more likely to form an emotional bond with a physical social robot 11. However, this bond is then transferred to the virtual avatars, which are configured to embody the same “personality” as the social robot 11, thereby appearing to correspond to the same entity. An advantage may be that the present embodiments address the problem known in the art of it being more difficult for users to form bonds with virtual avatars compared to physical objects such as social robots 11, for example, as discussed in reference [6].

Further modifications can be made without departing from the spirit and scope of the specification.

### CITATION LIST

[1] Khosla, Rajiv, Khanh Nguyen, Mei-Tai Chu, and Yu-Ang Tan. “Robot Enabled Service Personalisation Based On Emotion Feedback.” In Proceedings of the 14th International Conference on Advances in Mobile Computing and Multi Media, pp. 115-119. 2016.
[2] Khosla, Rajiv, Khanh Nguyen, and Mei-Tai Chu. “Socially assistive robot enabled personalised care for people with dementia in Australian private homes.” (2016).
[3] Khosla, Rajiv, Mei-Tai Chu, Seyed Mohammad Sadegh Khaksar, Khanh Nguyen, and Toyoaki Nishida. “Engagement and experience of older people with socially assistive robots in home care.” Assistive Technology (2019): 1-15.
[4] Khosla, Rajiv, Khanh Nguyen, and Mei-Tai Chu. “Service personalisation of assistive robot for autism care.” In IECON 2015-41st Annual Conference of the IEEE Industrial Electronics Society, pp. 002088-002093. IEEE, 2015.
[5] Khosla, Rajiv, Khanh Nguyen, and Mei-Tai Chu. “Assistive robot enabled service architecture to support home-based dementia care.” In 2014 IEEE 7th International Conference on Service-Oriented Computing and Applications, pp. 73-80. IEEE, 2014.
[6] Pan, Ye, and Anthony Steed. “A comparison of avatar-, video-, and robot-mediated interaction on users' trust in expertise.” Frontiers in Robotics and AI 3 (2016): 12.
[7] MATLDA (Applicant) at https://www.hc-inv.com/about-matlda

1.-37. (canceled)

38. A human interaction system for interaction by a user comprising social systems comprising at least a social robot and one or more virtual robot systems, and a coordination system, wherein:
the social robot is controlled by a robot processing system and is configured to provide interaction with a user, said interaction including output means and input means,
the one or more virtual robot systems are configured to controllably present an avatar representation of the social robot, and further configured to receive inputs,
the coordination system is configured to coordinate operation of the social robot and the one or more virtual robots such that, at any one time, either the social robot or one of the virtual robot systems is active,
such that, in operation, a user perceives a robot personality associated with the social robot and the avatar as associated with the active social robot or virtual robot system.

39. The system according to claim 38, wherein the social robot comprises at least one of:
one or more cameras and/or a microphone as input means;
a speaker and/or one or more lights as output means; and
a first portion, such as a head, moveable with respect to a second portion, such as a body.

40. The system according to claim 38, wherein the coordination system is configured to:
determine a location of the user and to determine a corresponding social system to the location of the user; and
communicate a message to the corresponding social system configuring it as active.

41. The system according to claim 40, wherein the coordination system is further configured to in response to determining the corresponding social system to the location of the user, communicate a message to the one or more other social systems configuring each as inactive.

42. The system according to claim 38, wherein the one or more virtual robot systems are configured to animate the avatar, and wherein at least one animation is equivalent to a movement of the social robot.

43. The system according to claim 38, wherein the robot processing system is configured to control, at least in part, the operation of an active virtual robot system.

44. The system according to claim 43, wherein the active virtual robot system is configured to interpret commands received from the robot processing system and adapt said commands for display on a display of the virtual robot system.

45. The system according to claim 38, wherein at least one virtual robot system is configured with at least two predefined avatar appearances, and wherein one of said predefined avatar appearances is selected in dependence on an application.

46. The system according to claim 45, wherein one of the at least two predefined avatar appearances is a neutral appearance.

47. The system according to claim 38, further comprising one or more interaction devices in data communication with the social robot and/or the one or more virtual robot systems, the interaction devices enabling the user to provide inputs and receive outputs.

48. The system according to claim 47, wherein at least one virtual robot system is configured to present a virtual object corresponding to one of the one or more interaction devices.

49. The system according to claim 38, wherein the avatar appearance is controllable in response to a user command to perform a verbal communication and/or a visual action.

50. A human interaction system for interaction by a user comprising social systems comprising at least a social robot and one or more virtual robot systems, wherein:
the social robot is controlled by a robot processing system and is configured to provide interaction with a control user, said interaction including output means and input means,
the one or more one or more virtual robot systems are configured to controllably present an avatar representation of the social robot, and further configured to receive inputs, wherein the, or each, virtual robot system is associated with a user,
such that, in operation, the, or each, user perceives a robot personality associated with the social robot and the avatar as associated with the active social robot or virtual robot system.

51. The system according to claim 50, wherein the one or more virtual robot systems are configured to animate the avatar, and wherein at least one animation is equivalent to a movement of the social robot and at least one animation is not equivalent to a movement of the social robot.

52. The system according to claim 50, further comprising one or more interaction devices in data communication with the social robot and/or virtual robot system(s), the interaction devices enabling the user to provide inputs and receive outputs.

53. The system according to claim 29, wherein at least one virtual robot system is configured to present a virtual object corresponding to an interaction device.

54. The system according to claim 20, wherein the social robot is configured to receive voice commands from the control user, wherein at least one voice command corresponds to a request for information from a particular virtual robot system, and wherein the social robot is further configured tovcommunicate said command to said particular virtual robot system.

55. The system according to claim 54, wherein at least one virtual robot system is further configured to:
receive a directed command;
undertake an associated action; and
communicate a response to the social robot.

56. The system according to claim 55, wherein at least one associate action comprises obtaining a result from an associated auxiliary device in communication with the associated virtual robot system.

57. A human interaction method for allowing interaction by a user with a social system comprising at least a social robot and one or more virtual robot systems, comprising:
controlling the social robot to provide interaction with a user, said interaction including output means and input means,
controllably presenting an avatar representation of the social robot on one or more displays, such that when an avatar representation is displayed on a display it is active, and
coordinating operation of the social robot and the one or more virtual robots such that, at any one time, either the social robot or one of the virtual robot systems is active,
such that, in operation, a user perceives a robot personality associated with the social robot and the avatar as associated with the active social robot or virtual robot system.
